(19) United States
(12) Patent Application Publication
(10) Pub. No.: US 2014/0015337 A1
(43) Pub. Date: Jan. 16, 2014

(54) POWER RECEIVING DEVICE HAVING TOUCH PANEL AND POWER TRANSMISSION SYSTEM FOR FEEDING POWER TO POWER RECEIVING DEVICE

(71) Applicants: Shinya Takeuchi, Kyoto-shi (JP); Shinji Goma, Nagaokakyo-shi (JP); Kazuya Kato, Nagaokakyo-shi (JP)

(72) Inventors: Shinya Takeuchi, Kyoto-shi (JP); Shinji Goma, Nagaokakyo-shi (JP); Kazuya Kato, Nagaokakyo-shi (JP)

(21) Appl. No.: 14/007,503

(22) PCT Filed: Mar. 15, 2012
(86) PCT No.: PCT/JP2012/056692

§ 371 Date: Sep. 25, 2013

(30) Foreign Application Priority Data
Mar. 30, 2011 (JP) 2011-076323

(51) Int. Cl. H02J 17/00

(52) U.S. Cl. CPC H02J 17/00
USPC 307/104

(57) ABSTRACT

To provide a power receiving device having high power-receiving efficiency, able to be fed with power in a short time, and having made lighter and thinner with a smaller number of parts, and a power transmission system for feeding power to the power receiving device with high efficiency, the power receiving device has a resistive film type touch panel which has a movable transparent electrode membrane and a fixed transparent electrode membrane and causes a control unit to perform control to selectively switch between a position detecting circuit which detects a contact position on the touch panel and a power receiving circuit which supplies power received by using a movable transparent electrode as a power receiving electrode in an electric field coupling system to a secondary battery, and the power transmission system includes a power transmitting device which has a power transmission electrode for transmitting power by the electric field coupling system by using the movable transparent electrode membrane as a power receiving electrode in response to the power receiving device placed on the power transmitting device.

### TECHNICAL FIELD

The present invention relates to a power receiving device having a touch panel and a power transmission system for feeding power to the power receiving device, and particularly to a wireless power transmission system which feeds power to the power receiving device without contact.

### BACKGROUND ART

As conventional power receiving devices having touch panels, various electronic appliances have been known and the various electronic appliances have been used in a wide range of fields such as mobile phone sets, handheld game players, digital cameras, personal data assistants (PDAs), digital audio devices, and digital information devices. In recent years, these power receiving devices, each of which has a touch panel provided with a touch sensor made of a transparent electrode film over a display such as a liquid crystal display panel, have been used for many electronic appliances (see Patent Document 1). Since these power receiving devices are portable, the devices have secondary batteries, which are storage batteries, and are configured to be driven by the power output from the secondary batteries.

As a conventional power transmission system which feeds power to (charge) the secondary battery, a wireless power transmission method which uses the principle of electromagnetic induction (see Patent Document 2) has been known other than a general power feeding method for feeding power to the secondary battery from a main power source by a cable. As another wireless power transmission method, a power feeding method of an electric field coupling system through a capacitive coupling has been proposed (see Patent Document 3). The electric field coupling system is a system for transmitting power from a power supply circuit on the power transmitting side to a secondary battery circuit on the power receiving side with electrodes of the power transmitting side and the power receiving side placed in close proximity to each other to cause electric-field coupling (capacitive coupling).

### CITATION LIST

### Patent Literatures

Patent Document 1: JP 07-013695 A

Patent Document 2: JP 2008-300398 A

Patent Document 3: JP 2009-531009 A

### SUMMARY OF INVENTION

### Technical Problem

Feeding of power to a secondary battery, which is a storage battery, in a short time with high efficiency is an important problem for the above described portable power receiving devices having touch panels, and a configuration which enables power feeding by a simple operation is another important problem to be solved for the devices. Further, a recent trend toward more compact, lighter, and thinner portable power receiving devices will be much more spurred in future. In accordance with the trend, spaces for arranging the respective parts in the power receiving devices have become more limited, therefore, the parts are required to be smaller and the devices are required to have simpler configurations, which are also important problems to be solved. Also, building of a power transmission system for feeding power to such power receiving devices easily with high efficiency is an important problem to be solved as well as providing the above described power receiving devices.

### Solution to Problem

In a present invention, in order to overcome the aforementioned problem, a power receiving device of a first aspect of according to the present invention comprises a touch panel which is provided on a display panel with a movable transparent electrode membrane and a fixed transparent electrode membrane facing each other and functions as a resistive film type touch sensor;
a position detecting circuit which detects a touched position on the touch panel;
a power receiving circuit which supplies a secondary battery with power received by the movable transparent electrode, the movable transparent electrode serving as an electric field coupling system power receiving antenna; and
a control unit which performs control to selectively switch between the power receiving circuit and the position detecting circuit to drive any one of the circuits.

In the first aspect of the power receiving device configured as described above, since a movable transparent electrode membrane in a touch sensor, which is practically exposed as the exterior surface and has a wide area, is used as a power receiving antenna (power receiving electrode) in the electric field coupling system, power feeding in a short time with high power-receiving efficiency can be realized. Also, since the movable transparent electrode membrane in the touch sensor is also used as a part of a power receiving mechanism, therefore, the movable transparent electrode membrane serves the both purposes, the device can be made lighter and thinner with a smaller number of parts.

A power receiving device of a second aspect of according to the present invention is configured that the control unit of the above-mentioned first aspect is configured to perform control to switch from the position detecting circuit to the power receiving circuit so that power is fed to the secondary battery via the movable transparent electrode, when the movable transparent electrode membrane is ready to transmit power.

The second aspect of the power receiving device configured as described above enables the power feeding by a simple operation.

A power receiving device of a third aspect of according to the present invention is configured that the movable transparent electrode membrane of the above-mentioned first aspect is configured to function as a passive electrode in an electric field coupling system.

The third aspect of the power receiving device configured as described above can be made more compact, lighter, and thinner and can perform the highly efficient power feeding.

A power receiving device of a fourth aspect of according to the present invention is configured that the touch panel of the above-mentioned first aspect is split into at least two sections with the movable transparent electrode membrane of the touch panel configured to function as a passive electrode and an active electrode in an electric field coupling system.

The fourth aspect of the power receiving device configured as described above can be made more compact, lighter, and thinner and can perform the power feeding with high efficiency.

A power receiving device of a fifth aspect of according to the present invention is configured that the movable transparent electrode membrane of the above-mentioned first aspect functions as a passive electrode in an electric field coupling system, and an active electrode in the electric field coupling system is arranged in parallel with the passive electrode on the same surface.

The fifth aspect of the power receiving device configured as described above can be made more compact, lighter, and thinner and can perform the power feeding with high efficiency.

A power receiving device of a sixth aspect of according to the present invention is configured that the movable transparent electrode membrane of the above-mentioned first aspect functions as a passive electrode in an electric field coupling system, and an active electrode in the electric field coupling system is arranged on a surface different from the surface on which the passive electrode is arranged.

The sixth aspect of the power receiving device configured as described above allows a freer design and can perform the power feeding with high efficiency.

A power receiving device of a seventh aspect of according to the present invention is configured that the touch panel of the above-mentioned first aspect includes a plurality of touch panel components, and a movable transparent electrode component in at least one touch panel component is configured to function as a passive electrode in an electric field coupling system, and when the movable transparent electrode component is ready to transmit power, the control unit is configured to perform control to switch from the position detecting circuit to the power receiving circuit so that power is fed to the secondary battery via the movable transparent electrode component.

The seventh aspect of the power receiving device configured as described above enables the power feeding by a simple operation.

A power receiving device of an eighth aspect of according to the present invention is configured that when the control unit of the above-mentioned seventh aspect performs control to switch to the power receiving circuit so that power is fed to the secondary battery, at least one of the movable transparent electrode components is configured to function as a touch sensor of the touch panel.

The eighth aspect of the power receiving device configured as described above enables the power feeding by a simple operation and also, when power is being fed, allows the touch sensor to be used, therefore, realizes a power receiving device with excellent operability and high usability.

A power transmission system of a ninth aspect of according to the present invention comprises a power receiving device which includes a secondary battery and has a touch panel, the touch panel being provided on a display panel with a movable transparent electrode membrane and a fixed transparent electrode membrane facing each other and functioning as a resistive film type touch sensor; and
a power transmitting device which includes a power transmission electrode on which the power receiving device is placed, the power transmitting device transmitting power through an electric field coupling system by employing the movable transparent electrode membrane as a power receiving electrode.

The ninth aspect of the power transmission system configured as described above has a configuration that can easily feed power from a power transmitting device to the power receiving device with high efficiency.

A power transmission system of a tenth aspect of according to the present invention is configured that the movable transparent electrode membrane of the power receiving device of the above-mentioned ninth aspect is configured to function as a passive electrode in the electric field coupling system, and when at least a part of the movable transparent electrode membrane faces a passive electrode of the power transmission electrode of the power transmitting device, the power transmission system is configured to perform power transmission.

The tenth aspect of the power transmission system configured as described above enables the power transmission/reception by a simple operation.

A power transmission system of an eleventh aspect of according to the present invention is configured that the touch panel of the power receiving device of the above-mentioned ninth aspect is split into at least two sections, and the movable transparent electrode membrane of the touch panel is configured to function as a passive electrode and an active electrode in the electric field coupling system, and when at least a part of the movable transparent electrode membrane faces a passive electrode and an active electrode of the power transmission electrode of the power transmitting device, the power transmission system is configured to perform power transmission.

The eleventh aspect of the power transmission system configured as described above allows a power receiving device to be more compact, lighter, and thinner and can build a highly efficient wireless power transmission system.

A power transmission system of a twelfth aspect of according to the present invention is configured that in the power receiving device of the above-mentioned ninth aspect, the movable transparent electrode membrane functions as a passive electrode in the electric field coupling system, and an active electrode and the passive electrode in the electric field coupling system are arranged in parallel on the same surface;
in the power transmitting device, an active electrode and a passive electrode in the electric field coupling system are arranged in parallel on the same surface; and
when power is fed from the power transmitting device to the power receiving device in the electric field coupling system, at least portions of the respective active electrodes and passive electrodes face each other.

The twelfth aspect of the power transmission system configured as described above allows a power receiving device to be more compact, lighter, and thinner and can build a highly efficient wireless power transmission system.

A power transmission system of a thirteenth aspect of according to the present invention is configured that in the power receiving device of the above-mentioned ninth aspect, the movable transparent electrode membrane functions as a passive electrode in the electric field coupling system, and an active electrode in the electric field coupling system and the passive electrode are arranged on different surfaces;
in the power transmitting device, an active electrode and a passive electrode in the electric field coupling system are arranged on different surfaces; and
when power is fed from the power transmitting device to the power receiving device in the electric field coupling system, at least portions of the respective active electrodes and passive electrodes face each other.

The thirteenth aspect of the power transmission system configured as described above allows a power receiving device to have a freer design and can perform the power feeding with high efficiency.

A power transmission system of a fourteenth aspect of according to the present invention is configured that in the power receiving device of the above-mentioned ninth aspect, the touch panel includes a plurality of touch panel components, and the movable transparent electrode component of at least one of the touch panel components functions as a passive electrode in the electric field coupling system; and
in the power transmitting device, a passive electrode is provided as a power transmission electrode which can move to the position facing the passive electrode of the power receiving device.

The fourteenth aspect of the power transmission system configured as described above enables the power transmission/reception by a simple operation.

A power transmission system of a fifteenth aspect of according to the present invention is configured that the power transmitting device of the above-mentioned fourteenth aspect is configured to pinch the power receiving device so that the passive electrode of the power transmitting device faces the passive electrode of the power receiving device.

The fifteenth aspect of the power transmission system configured as described above ensures performance of the power transmission/reception by a simple operation.

A power transmission system of a sixteenth aspect of according to the present invention is configured that when power is fed to the power receiving device of the above-mentioned fourteenth aspect, at least one of the movable transparent electrode components is configured to function as a touch sensor of the touch panel.

The sixteenth aspect of the power transmission system configured as described above enables the power transmission/reception by a simple operation and also, when power is being fed, allows the function of the touch sensor to be used.

### Advantageous Effects of Invention

According to the present invention, a power receiving device can be provided which has high power-receiving efficiency and can be fed with power in a short time and which can be made more compact, lighter, and thinner, and also a power transmission system can be provided which enables power transmission/reception with high efficiency by a simple operation.

### BRIEF DESCRIPTION OF DRAWINGS

FIG. 1 is a plan view of a power receiving device and a power transmitting device used in a power transmission system of a first embodiment according to the present invention.

FIG. 2 is a cross sectional view of a touch panel over a liquid crystal display panel of the power receiving device of the first embodiment.

FIG. 3 is a schematic diagram for describing the power transmission system of the first embodiment.

FIG. 4A is a plan view illustrating a power feeding state of the power transmission system of the first embodiment with the power receiving device placed on the power transmitting device.

FIG. 4B is a side view illustrating the power feeding state of the power transmission system of the first embodiment with the power receiving device placed on the power transmitting device.

FIG. 5 is a block diagram for describing the power transmission system of the first embodiment.

FIG. 6A is a plan view illustrating a power feeding state of a power transmission system of a second embodiment according to the present invention with a power receiving device placed on a power transmitting device.

FIG. 6B is a side view illustrating the power feeding state of the power transmission system of the second embodiment with the power receiving device placed on the power transmitting device.

FIG. 7 is a block diagram for describing the power transmission system of the second embodiment.

FIG. 8A is a plan view illustrating a power feeding state of a power transmission system of a third embodiment according to the present invention with a power receiving device placed on a power transmitting device.

FIG. 8B is a side view illustrating a state of the power transmission system of the third embodiment with the power receiving device placed on the power transmitting device.

FIG. 9 is a block diagram for describing the power transmission system of the third embodiment.

FIG. 10A is a perspective view illustrating a modification of a shape of the touch panel of the power receiving device used in the power transmission system of the present invention.

FIG. 10B is a perspective view illustrating another modification of the shape of the touch panel of the power receiving device used in the power transmission system of the present invention.

### DESCRIPTION OF EMBODIMENTS

Now, a PDA (Personal Data Assistant) having a mobile phone function, as a portable power receiving device having a touch panel, and a power transmission system for supplying power to the PDA will be described as preferable embodiments according to the present invention, however, the present invention is not limited to these specific configurations below, but may be applied to various electronic appliances which are configured based on the same technical idea as that described in the embodiments and the common general knowledge in the art and power transmission systems which supply power to these electronic appliances. In the power transmission system according to the present invention, a form of feeding power to a power receiving device by an electric field coupling (capacitive coupling) system is used.

### First Embodiment

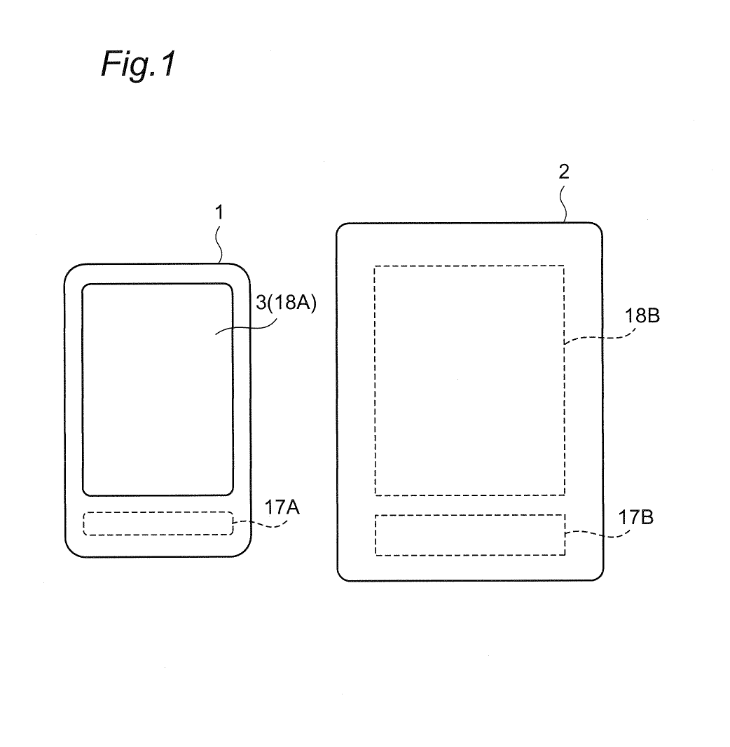

FIG. 1 is a plan view of a power receiving device 1 and a power transmitting device 2 which feeds power to (charges) the power receiving device 1 used in a power transmission system of the first embodiment according to the present invention. In FIG. 1, the power receiving device 1 is a PDA having a mobile phone function with a touch panel 3 provided on most of the entire surface as an operation surface. The power receiving device 1 is an appliance to be charged and includes a secondary battery (not shown). In the power transmission system of the first embodiment, the power transmitting device 2 which wirelessly feeds power (performs wireless power transmission) to the secondary battery of the power receiving device 1 is provided.

In the power transmission system of the first embodiment, wireless power transmission to the power receiving device 1 is performed by an electric field coupling system with the power receiving device 1 placed on the power transmitting device 2. In order to supply power by the electric field coupling system, it is required to place an electrode provided on the power receiving device 1 in close proximity to an electrode provided on the power transmitting device 2 to face each other to cause capacitive coupling. In the power transmission system of the first embodiment, the touch panel 3 is provided on the surface of the power receiving device 1, so that a transparent electrode of the touch panel 3 is used as a power receiving antenna for the wireless power transmission.

Now, a case where the transparent electrode of the touch panel 3 is used as the power receiving antenna, i.e., as a power receiving electrode, in the first embodiment will be described.

First, a configuration for receiving power of the power receiving device 1, which is an appliance to be charged in the power transmission system of the first embodiment will be described.

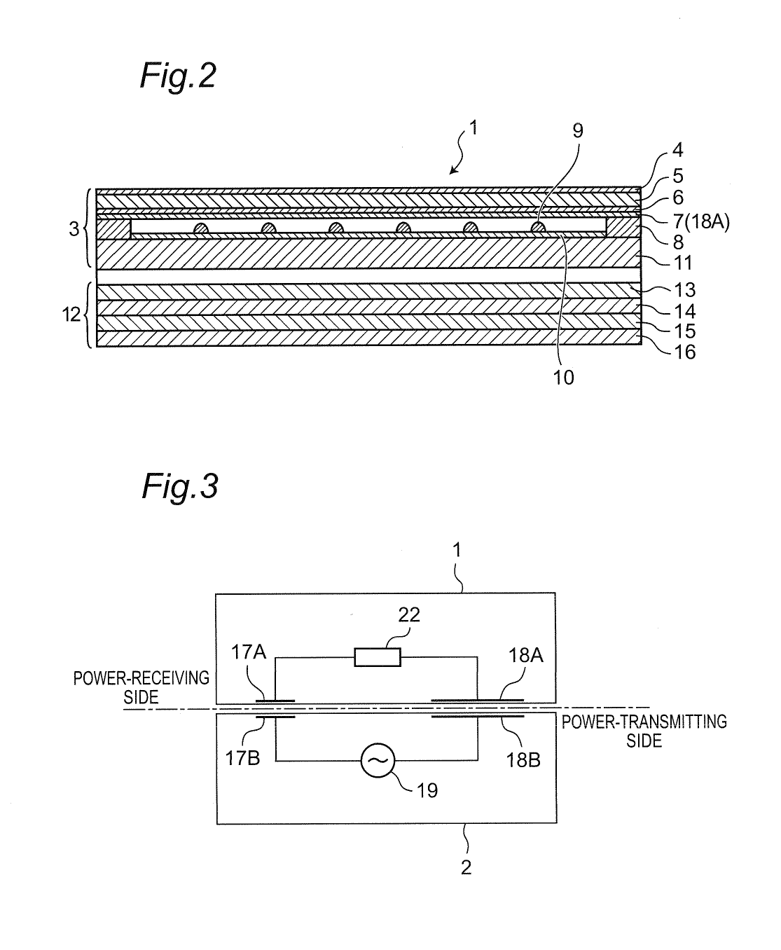

FIG. 2 is a cross sectional view of the touch panel 3 over a liquid crystal display panel in the power receiving device 1. In FIG. 2, the touch panel 3 has a hard coat layer 4, a movable-side film 5, a shrinkable resin film 6, a movable transparent electrode membrane 7, a fixed transparent electrode membrane 10, and a fixed-side support medium 11 in order from the surface (upper side of FIG. 2), with spacer 9 arranged between the movable transparent electrode membrane 7 and the fixed transparent electrode membrane 10. The movable-side film 5, the movable transparent electrode membrane 7, the fixed transparent electrode membrane 10, and the fixed-side support medium 11 are adhered together at the periphery parts by a periphery adhesion layer 8.

For the movable transparent electrode membrane 7, a transparent conductive film made of metals such as gold, silver, copper, tin, nickel, and palladium, or metal oxides such as tin oxide, indium oxide, antimony oxide, zinc oxide, cadmium oxide, and indium tin oxide (ITO) is used. For a method of forming the movable transparent electrode membrane 7, a vacuum deposition process, a sputtering method, an ion plating method, and a CVD process are used.

The fixed transparent electrode membrane 10 is formed on the top of the fixed-side support medium 11 which is made of a transparent film or a transparent glass, and a transparent conductive film made of ITO or the like is used for the fixed transparent electrode membrane 10 like the above described movable transparent electrode membrane 7.

The spacer 9 is for maintaining a space between the movable transparent electrode membrane 7 and the fixed transparent electrode membrane 10, and is formed in a photoprocess on a transparent resin such as photosensitive acryl or photosensitive polyester in the form of a plurality of small dots. For the spacer 9, a plurality of small dots formed by a printing process may also be used.

Across a gap under the touch panel 3 of the above described configuration, a display panel 12 is provided. The display panel 12 in the first embodiment is a liquid crystal display panel and includes a deflecting plate 13, a color filter substrate 14, a TFT substrate 15, and a deflecting plate 16.

The power receiving device 1 of the first embodiment is configured to respond to user's contact operation (touch operation) on a display surface of the touch panel 3, which is the operation surface of the power receiving device 1, by outputting a voltage signal corresponding to the contact position to a control unit 20 as a position detection signal (described later).

In the power receiving device 1 of the first embodiment, as described above, the movable transparent electrode membrane 7 of the touch panel 3 functions as a power receiving antenna (power receiving electrode) in the electric field coupling system.

Now, a power feeding method in the electric field coupling system for supplying power between the power receiving device 1 and the power transmitting device 2 in the first embodiment will be described.

FIG. 3 is a schematic diagram for describing the power transmission system of the first embodiment. In FIG. 3, the power receiving device 1 is provided with a power-receiving side active electrode 17A and a power-receiving side passive electrode 18A. On the other hand, the power transmitting device 2 is provided with a power-transmitting side active electrode 17B and a power-transmitting side passive electrode 18B. In the case where power is supplied from the power transmitting device 2 to the power receiving device 1, the power-receiving side active electrode 17A and the power-transmitting side active electrode 17B, and the power-receiving side passive electrode 18A and the power-transmitting side passive electrode 18B are arranged to face each other, respectively, to cause the capacitive coupling. In the case where the capacitive coupling occurs, power is supplied from a power transmission circuit 19 of the power transmitting device 2 to a power receiving circuit 22 of the power receiving device 1 via the active electrodes 17A and 17B and the passive electrodes 18A and 18B. In the power receiving circuit 22, the power is rectified and smoothed for charging the secondary battery of the power receiving circuit 22. In the power receiving circuit 22, a predetermined amount of electric charge is stored in the secondary battery. When a predetermined voltage is reached, the charging operation to the secondary battery finishes.

In the power feeding method in the electric field coupling system, the movable transparent electrode membrane 7 of the power receiving device 1 in the first embodiment is used as the power-receiving side passive electrode 18A. Since the power receiving device 1 of the first embodiment is configured to expose the touch panel 3 on the surface, it is possible to place the touch panel 3 in close proximity to the power transmitting device 2.

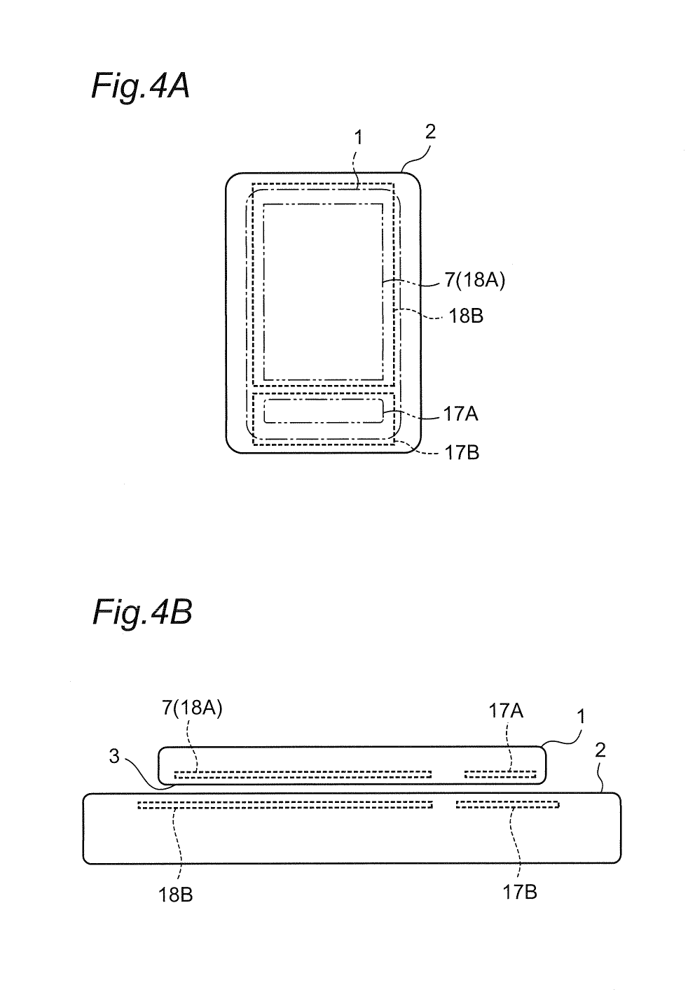

FIG. 4A is a plan view illustrating the power receiving device 1 (dash-dot line) placed on the power transmitting device 2 (solid line), showing a power feeding state. FIG. 4B is a side view illustrating the power feeding state with the power receiving device 1 placed on the power transmitting device 2. As shown in FIGS. 4A and 4B, in the power feeding state, the active electrode 17A (dash-dot-dot line in FIG. 4A) and the passive electrode 18A (dash-dot-dot line in FIG. 4A), which are the power receiving antennae of the power receiving device 1, are arranged to face the active electrode 17B (dashed line) and the passive electrode 18B (dashed line), which are the power transmitting antennae of the power transmitting device 2, being arranged in close proximity to each other. Here, as the passive electrode 18A of the power receiving device 1, i.e., as the power receiving antenna, the movable transparent electrode membrane 7 of the touch panel 3 which has functioned as the touch sensor (position sensor) is used.

As illustrated in FIG. 4B, the power receiving device 1 of the first embodiment has the active electrode 17A and the passive electrode 18A placed in parallel on the same plane. Similarly, the power transmitting device 2 has the active electrode 17B and the passive electrode 18B placed in parallel on the same plane. Although the first embodiment has been described by a configuration example in which the active electrodes 17A and 17B and the passive electrodes 18A and 18B in the power receiving device 1 and the power transmitting device 2 are in a planar shape, the present invention is not limited to the configuration example. In the present invention, the active electrodes and the passive electrodes may be configured to be in shapes having at least partly curved surfaces, and the configuration only needs to have at least portions of the respective active electrodes and passive electrodes face each other to be ready for power transmission.

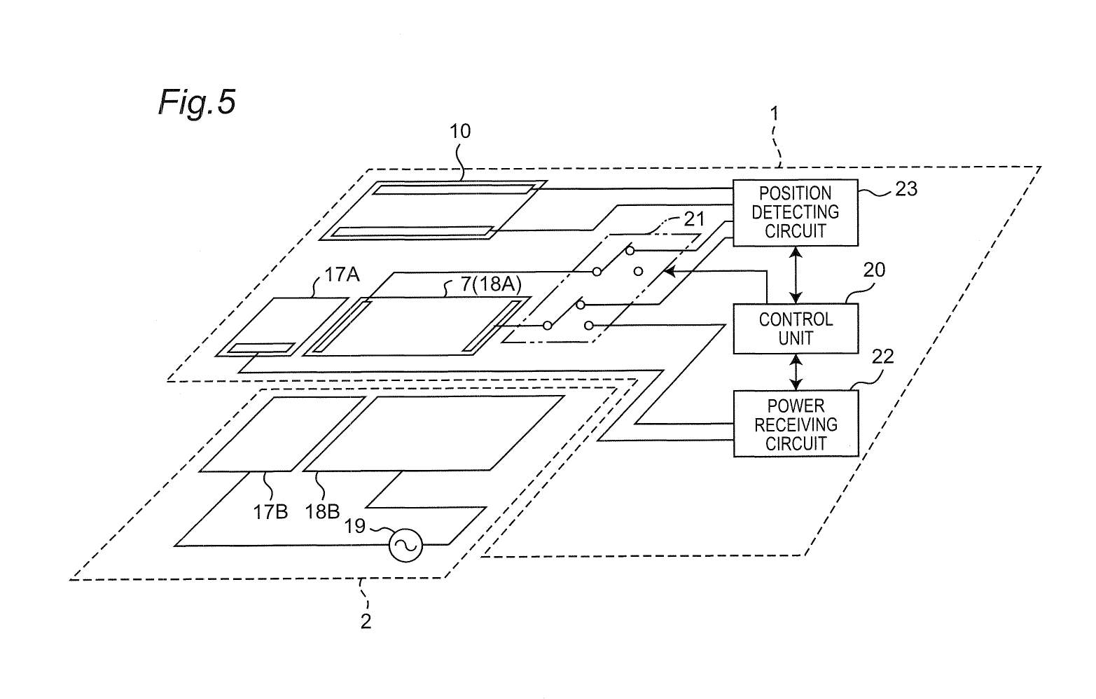

FIG. 5 is a block diagram for describing the power transmission system of the first embodiment. In FIG. 5, only the movable transparent electrode membrane 7 and the fixed transparent electrode membrane 10 in the touch panel 3 of the power receiving device 1 are illustrated as elements of the touch sensor.

As illustrated in FIG. 5, a control unit 20 including a switch unit 21, the power receiving circuit 22, and the position detecting circuit 23 are provided for the power receiving device 1 as constituent elements associated with the power transmission system. In FIG. 5, the other functionally necessary elements of the power receiving device 1 such as a liquid crystal display panel and the respective elements necessary for the PDA function are omitted.

As illustrated in FIG. 5, when the control unit 20 of the power receiving device 1 detects that the power receiving device 1 is placed on the power transmitting device 2 to be ready for power transmission, the control unit 20 performs a switching operation by the switch unit 21, and then, in response to the switching operation, the movable transparent electrode membrane 7 of the touch panel 3 is switched to be the power-receiving side passive electrode 18A to function as the power receiving antenna. As a result, the power receiving device 1 has power supplied from the power transmitting device 2 by the electric field coupling system, so that the secondary battery of the power receiving circuit 22 is charged.

When the power receiving device 1 is placed on the power transmitting device 2 (power feeding state) and at least portions of the respective active electrodes and passive electrodes face each other, the control unit 20 determines that the electrodes are ready for the power transmission and proceeds to the switching operation to perform the power feeding operation.

When the secondary battery has been charged or when the user takes the power receiving device 1 away from the power transmitting device 2 by a predetermined distance to make the power receiving device 1 function as the PDA, the control unit 20 detects the states of the devices and switches the movable transparent electrode membrane 7 by the switch unit 21 to function as the touch sensor (position sensor).

Although the first embodiment has been described by an example in which the passive electrode 18A of the power receiving device 1 is configured with the movable transparent electrode membrane 7 of the touch panel 3, the present invention is not limited to the configuration and, for example, the touch panel may be split into a plurality of sections so that both of the passive electrode and the active electrode are caused to function by two movable transparent electrode membranes.

In the power receiving device 1 of the first embodiment configured as described above, the movable transparent electrode membrane 7 in the touch sensor, which is practically exposed as the exterior surface and has a wide area, is used as the power receiving antenna in the electric field coupling system. Therefore, with the power transmission system of the first embodiment, the power receiving device 1 is enabled to feed power in a short time with high power-receiving efficiency, and since the movable transparent electrode membrane 7 in the touch sensor is also used as the power receiving antenna, the power receiving device 1 can be made lighter and thinner with a smaller number of parts.

In the power receiving device 1 and the power transmission system of the first embodiment configured as described above, the power receiving device 1, which is an appliance to be charged, can be configured to be enabled to feed power in a short time with high efficiency and also be enabled to feed power by a simple operation. Further, according to the configuration of the first embodiment, the important problem of portable power receiving devices which requires the devices to be made more compact, lighter, and thinner can be easily solved.

### Second Embodiment

A PDA as a portable power receiving device and a power transmission system which supplies power to the power receiving device of the second embodiment according to the present invention will be described below with reference to the attached drawings. Also in the power transmission system of the second embodiment, supply of power from the power transmitting device to the power receiving device is performed by the electric field coupling system.

The power receiving device and the power transmission system of the second embodiment are different from those in the configuration of the first embodiment in the arrangement of the active electrodes and the passive electrodes to serve as the power receiving antennae and the power transmitting antennae, in the position of the touch panel of the power receiving device, and in that the display panel under the touch panel is made of materials which enable electromagnetic wave transmission. The other parts of the configurations of the power receiving device and the power transmission system of the second embodiment are the same as those of the first embodiment. Therefore, in the second embodiment, the same reference signs are given to the parts which have the same functions and the same operations as those in the first embodiment, and description of these parts of the first embodiment will be incorporated in the description below.

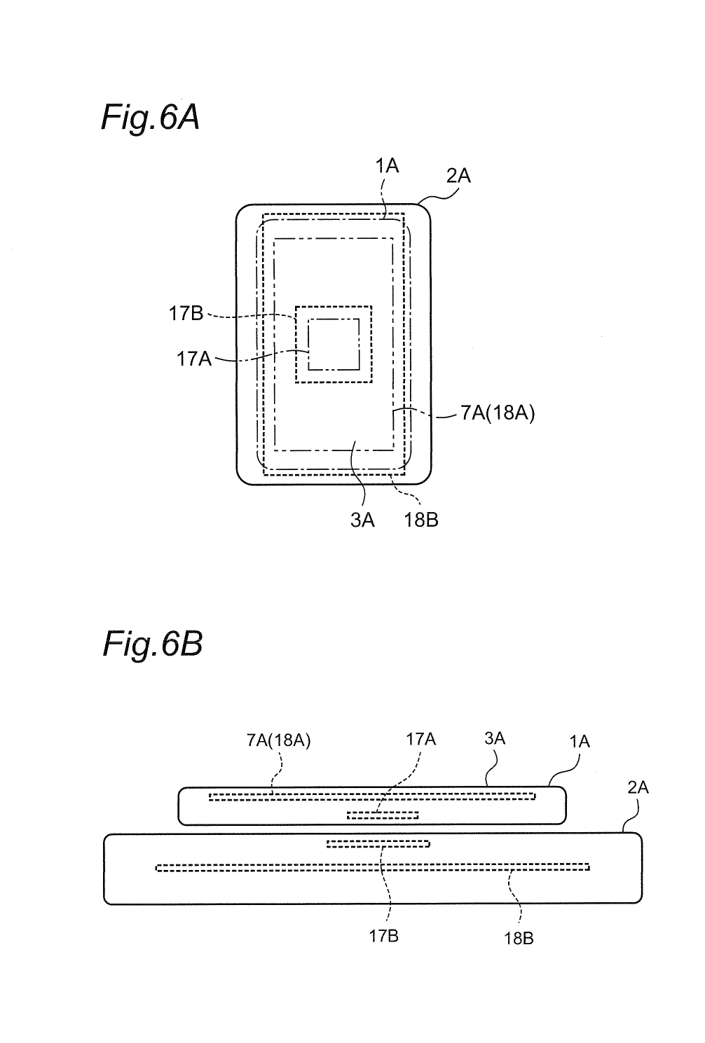

FIG. 6A is a plan view illustrating a power receiving device 1A (dash-dot line) placed on a power transmitting device 2A (solid line), showing a power feeding state. FIG. 6B is a side view illustrating the power feeding state with the power receiving device 1A placed on the power transmitting device 2A.

As illustrated in FIGS. 6A and 6B, in the power feeding state of the second embodiment with the power receiving device 1A placed on the power transmitting device 2A, the power receiving device 1A is placed upward to allow a touch panel 3A to be viewed. Therefore, the power receiving device 2 of the second embodiment is configured to allow an image display on the display panel to be viewed even in the power feeding state.

In the case where power is fed from the power transmitting device 2A to the power receiving device 1A in the power transmission system of the second embodiment, the power receiving device 1A is placed on the power transmitting device 2A, so that the active electrode 17A (an electrode in an almost square shape indicated by a dash-dot-dot line in FIG. 6A) of the power receiving device 1A is placed in close proximity to the active electrode 17B (an electrode in an almost square shape indicated by a dashed line in FIG. 6A) of the power transmitting device 2A to face each other. In that power feeding state, the touch panel 3A of the power receiving device 1A is exposed, whereas a movable transparent electrode membrane 7A of the touch panel 3A, which is the passive electrode 18A (an electrode in an almost rectangle indicated by a dash-dot-dot line in FIG. 6A) of the power receiving device 1A, is placed to face the passive electrode 18B (an electrode in an almost rectangle indicated by a dashed line in FIG. 6A) of the power transmitting device 2A.

As illustrated in FIG. 6A, the power receiving device 1A of the second embodiment has the active electrode 17A overlap the passive electrode 18A and the both electrodes 17A and 18A are arranged in the center area of the power receiving device 1A. Similarly, the power transmitting device 2A has the active electrode 17B overlap the passive electrode 18B and the both electrodes 17B and 18B are arranged in the center area of the power transmitting device 2A. As a result, as far as the power receiving device 1A and the power transmitting device 2A are placed to have the respective center areas face each other, the devices are ready for the power transmission. Therefore, as far as the power receiving device 1A and the power transmitting device 2A have the respective centers face each other, the devices enters the power feeding state and the power receiving device 1A is enabled for the power transmission at any angle with respect to the surface of the power transmitting device 2A placed on the power receiving device 1A.

As described above and illustrated in FIG. 6B, the power receiving device 1A of the second embodiment has the active electrode 17A and the passive electrode 18A arranged on the different planes. Also in the power transmitting device 2A, the active electrode 17B and the passive electrode 18B are arranged on the different planes. Although the second embodiment will be described by a configuration example in which the active electrodes 17A and 17B and the passive electrodes 18A and 18B in the power receiving device 1A and the power transmitting device 2A are in a planar shape, the present invention is not limited to the configuration example. In the present invention, the active electrodes and the passive electrodes may be configured to be in shapes having at least partly curved surfaces, and the configuration only needs to have at least portions of the respective active electrodes and passive electrodes face each other to be ready for the power transmission.

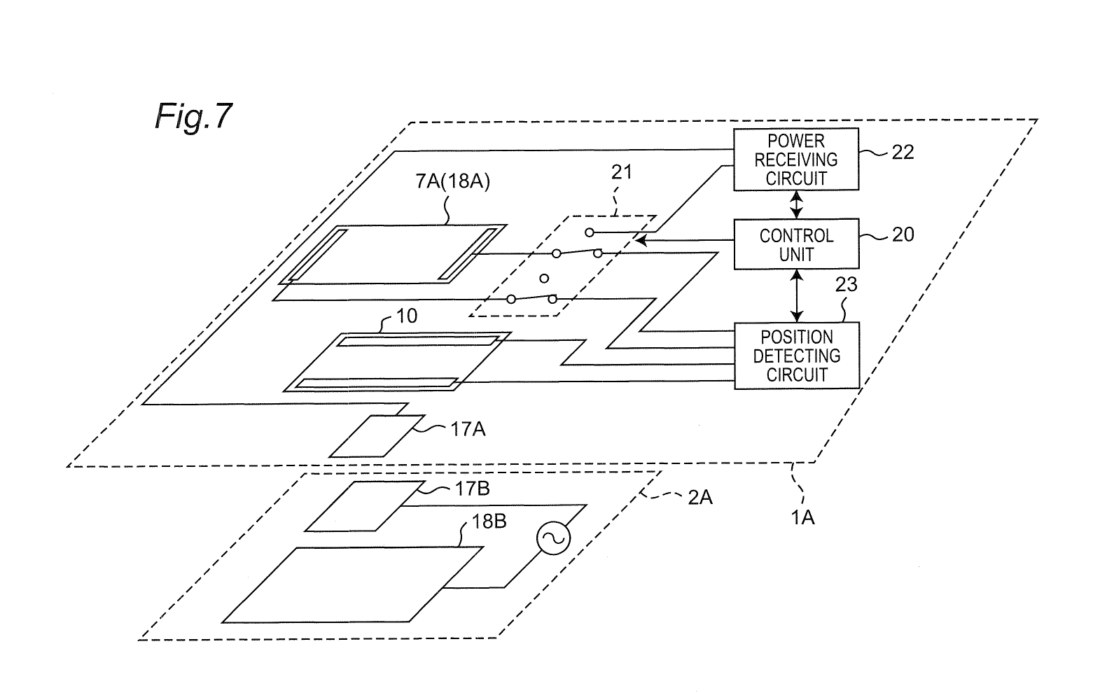

FIG. 7 is a block diagram for describing the power transmission system of the second embodiment. In FIG. 7, only the movable transparent electrode membrane 7A and the fixed transparent electrode membrane 10 in the touch panel 3A of the power receiving device 1A are illustrated as elements of the touch sensor.

As described in FIG. 7, the basic configuration of the power receiving device 1A and the power transmitting device 2A is the same as that of the power receiving device 1 and the power transmitting device 2 of the above described first embodiment illustrated in FIG. 5.

As the constituent elements of the power transmission system of the second embodiment, the control unit 20 including the switch unit 21, the power receiving circuit 22, and the position detecting circuit 23 are provided to form the same configuration as that of the first embodiment. The respective operations in the power transmission and the position detection of the second embodiment are also the same as those of the first embodiment.

As illustrated in FIG. 7, when the control unit 20 of the power receiving device 1A detects that the power receiving device 1A is placed on the power transmitting device 2A to be in the power transmission state, the control unit 20 performs the switching operation by the switch unit 21, and then, the movable transparent electrode membrane 7A of the touch panel 3A is switched to function as the power receiving antenna. That is, the movable transparent electrode membrane 7A is switched to the power-receiving side passive electrode 18A. As a result, the power receiving device 1A has power supplied from the power transmitting device 2A by the electric field coupling system with high efficiency, so that the secondary battery of the power receiving circuit 22 is charged.

When the secondary battery has been charged or when the user takes the power receiving device 1A away from the power transmitting device 2A by a predetermined distance to make the power receiving device 1A function as the PDA, the control unit 20 detects the states of the devices and switches the movable transparent electrode membrane 7A by the switch unit 21 to function as the touch sensor (position sensor).

In the power receiving device 1A of the second embodiment configured as described above, the movable transparent electrode membrane 7A in the touch sensor, which is practically exposed as the exterior surface and has a wide area, is used as the power receiving antenna in the electric field coupling system. As a result, according to the power transmission system of the second embodiment, the power receiving device 1A is enabled to feed power in a short time with high efficiency. Also, according to the configuration of the second embodiment, since the movable transparent electrode membrane 7A in the touch sensor is also used as the power receiving antenna, the device can be made lighter and thinner with a smaller number of parts.

Further, in the power transmission system of the second embodiment, the active electrodes 17A and 17B and the passive electrodes 18A and 18B of the power receiving device 1A and the power transmitting device 2A are arranged in the respective center areas. Therefore, in the second embodiment, when the power receiving device 1A and the power transmitting device 2A are placed to have the respective center areas face each other, the devices are ready for the power transmission and the power receiving device 1A can be easily fed with power at any angle within the surface of the power transmitting device 2A placed on the power receiving device 1A.

### Third Embodiment

A PDA as the portable power receiving device and the power transmission system which supplies power to the power receiving device of the third embodiment according to the present invention will be described below with reference to the attached drawings. Also in the power transmission system of the third embodiment, supply of power from the power transmitting device to the power receiving device is performed by the electric field coupling system.

The power receiving device and the power transmission system of the third embodiment are different from the configuration of the first embodiment in the arrangement of the active electrodes and the passive electrodes to serve as the power receiving antennae and the power transmitting antennae and in the position and the configuration of the touch panel of the power receiving device. The other parts of the configurations of the power receiving device and the power transmission system of the third embodiment are the same as those of the first embodiment, therefore, in the third embodiment, the same reference signs are given to the parts which have the same functions and the same operations as those in the first embodiment, and description of these parts of the first embodiment will be incorporated in the description below.

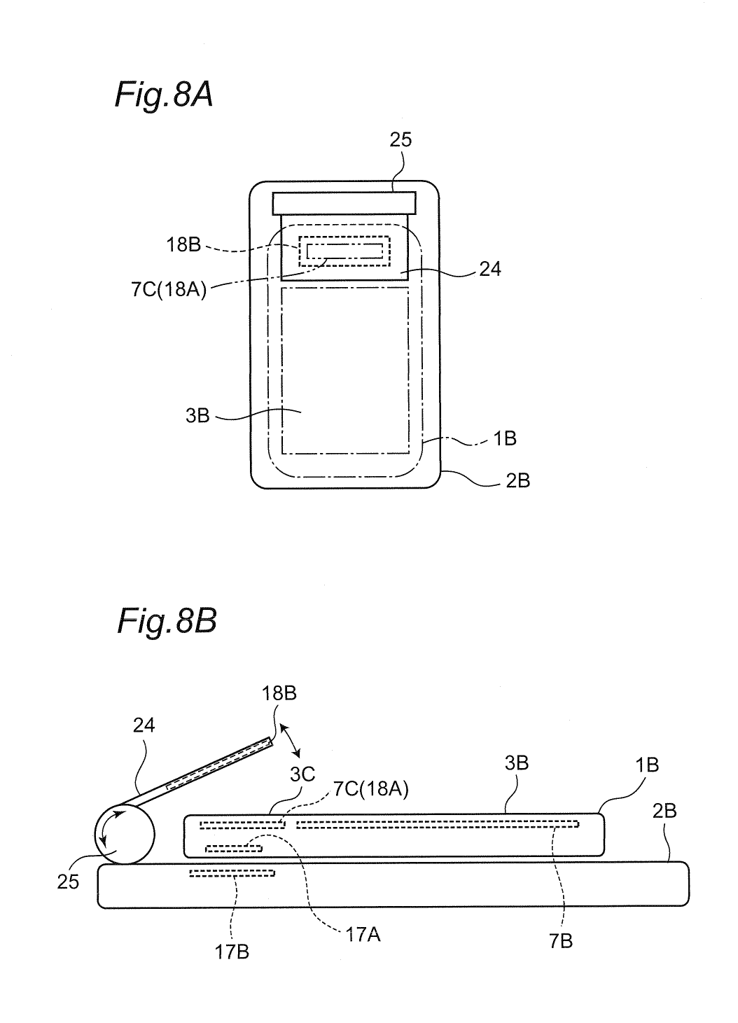

FIG. 8A is a plan view illustrating a power receiving device 1B (dash-dot line) placed on a power transmitting device 2B (solid line), showing a power feeding state. FIG. 8B is a side view illustrating the power receiving device 1B placed on the power transmitting device 2B.

As illustrated in FIGS. 8A and 8B, the touch panel of the power receiving device 1B includes two touch panel components 3B and 3C. A first touch panel 3B is configured to function as a touch sensor (position sensor) both in the power feeding state and the non-power feeding state. A second touch panel component 3C functions as the power receiving antenna in the power feeding state and functions as the touch sensor in the non-power feeding state, configured to serve the both purposes of the power receiving antenna and the touch sensor.

A first touch panel component 3B and the second touch panel component 3C in the third embodiment respectively have the same configurations and the same functions as those of the touch panel 3 described in the first embodiment. Therefore, the first touch panel component 3B and the second touch panel component 3C have their movable transparent electrode components which serve as the movable transparent electrode membrane and their fixed transparent electrode components which serve as the fixed transparent electrode membrane arranged to face each other across a predetermined gap, respectively, and have the function of the touch sensor. Although the respective fixed transparent electrode components of the first touch panel component 3B and the second touch panel component 3C are shown by the configuration example in which each of the fixed transparent electrode components is split into two sections, these sections may be integrated into one component. In the third embodiment configured as described above, the movable transparent electrode component of the second touch panel component 3C not only functions as the touch sensor but also functions as the power receiving antenna (passive electrode).

As illustrated in FIGS. 8A and 8B, in the power transmission system of the third embodiment, when the power receiving device 1B is placed on the power transmitting device 2B, a rotatable power transmitting unit 24 provided on the power transmitting device 2B is rotated on a rotating shaft 25 to pinch a portion of the power receiving device 1B. In the configuration of the third embodiment, when the power transmitting unit 24 of the power transmitting device 2B pinches a portion of the power receiving device 113, the power-transmitting side passive electrode 18B which is formed on the power transmitting unit 24 is configured to be placed to cover the second touch panel component 3C of the power receiving device 1B to cause a movable transparent electrode component 7C (18A) of the second touch panel component 3C to function as the power-receiving side passive electrode (power receiving antenna). Therefore, in the power receiving device 1B pinched by the power transmitting unit 24 of the power transmitting device 2B, the second touch panel component 3C is arranged to face the passive electrode 18B of the power transmitting unit 24 in close proximity to each other (state of ready for the power transmission).

In the power transmission system of the third embodiment, when in the state of ready for the power transmission, the first touch panel component 3B of the power receiving device 1B is placed upward to be exposed. Therefore, the power receiving device 1B of the third embodiment is configured to allow the first touch panel component 3B of the power receiving device 1B to be used as the touch sensor even in the state of ready for the power transmission.

Incidentally, the passive electrode 18B of the power transmitting unit 24 provided for the power transmitting device 2B may be configured with a transparent electrode, so that the power transmitting unit 24 is made as a transparent body. With the power transmitting unit 24 and the passive electrode 18B made by transparent materials as described above, the power transmission system is configured to allow the display image on the second touch panel component 3C to be viewed even in the power feeding state.

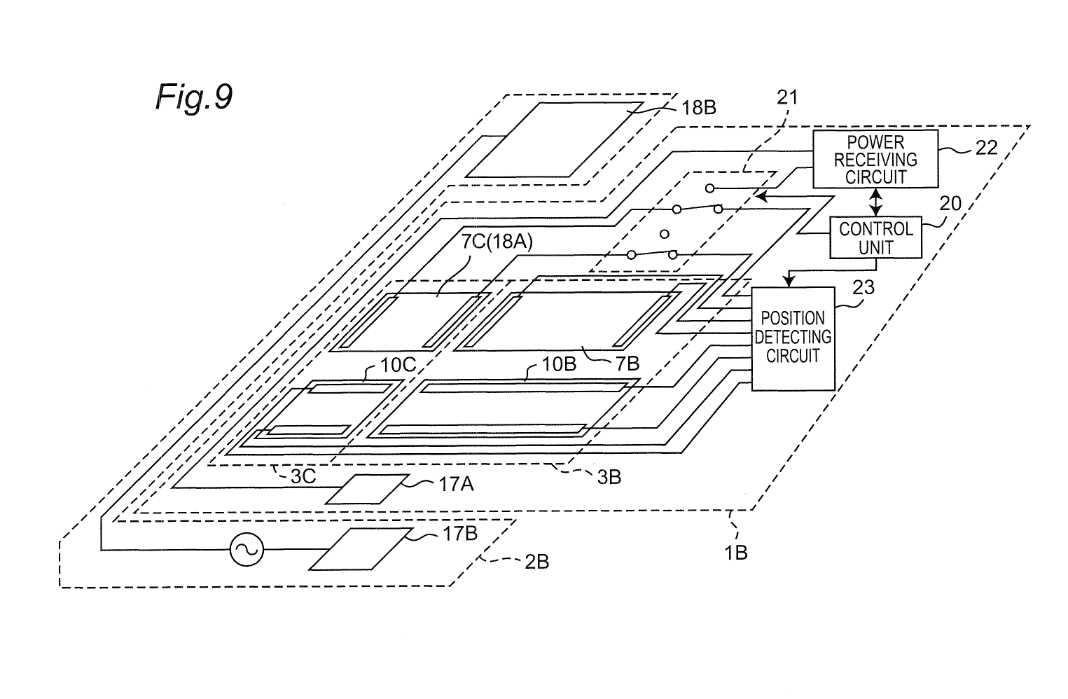

FIG. 9 is a block diagram for describing the power transmission system of the third embodiment. In FIG. 9, only movable transparent electrode components 7B and 7C and fixed transparent electrode components 10B and 10C in the two touch panels 3B and 3C of the power receiving device 1B are illustrated as elements of the touch sensor. Although the third embodiment has been described by the configuration example in which the fixed transparent electrode membrane is split into the two fixed transparent electrode components 10B and 10C, these components may be integrated into one component. As described in FIG. 9, the basic configurations of the power receiving device 1B and the power transmitting device 2B are the same as those of the power receiving device 1 and the power transmitting device 2 of the above described first embodiment illustrated in FIG. 5.

As the constituent elements of the power transmission system of the third embodiment, the control unit 20 including the switch unit 21, the power receiving circuit 22, and the position detecting circuit 23 are provided to form the same configuration as that of the first embodiment, and the respective operations in the power transmission and the position detection are also the same as those of the first embodiment. However, in the third embodiment, the movable transparent electrode component 7C of the second touch panel component 3C is used with the function as the touch sensor and the function as the power receiving antenna (passive electrode) switched.

As illustrated in FIG. 9, when the control unit 20 of the power receiving device 1B detects that the power receiving device 1B is placed on the power transmitting device 2B and pinched by the power transmitting unit 24 to be ready for the power transmission, the control unit 20 performs the switching operation by the switch unit 21 to switch the movable transparent electrode component 7C of the second touch panel component 3C to function as the power receiving antenna. That is, the movable transparent electrode component 7C of the second touch panel component 3C is switched to be the power-receiving side passive electrode 18A. As a result, the power receiving device 1B has power securely supplied from the power transmitting device 2B by the electric field coupling system with high efficiency, so that the secondary battery of the power receiving circuit 22 is charged.

When the secondary battery has been charged or when the user takes the power receiving device away from the power transmitting device 2B by a predetermined distance to make the power receiving device function as the PDA, the control unit 20 detects the states of the devices and switches the movable transparent electrode component 7C by the switch unit 21 to function as the touch sensor (position sensor).

In the power receiving device 1B of the third embodiment configured as described above, since the movable transparent electrode component 7C in the touch sensor, which is practically exposed as the exterior surface, is used as the power receiving antenna in the electric field coupling system, the power receiving device 1B is easily enabled for the power feeding with high power-receiving efficiency. Also, according to the configuration of the third embodiment, since the movable transparent electrode component 7C in the touch sensor also functions as the power receiving antenna, the device can be made lighter and thinner with a smaller number of parts.

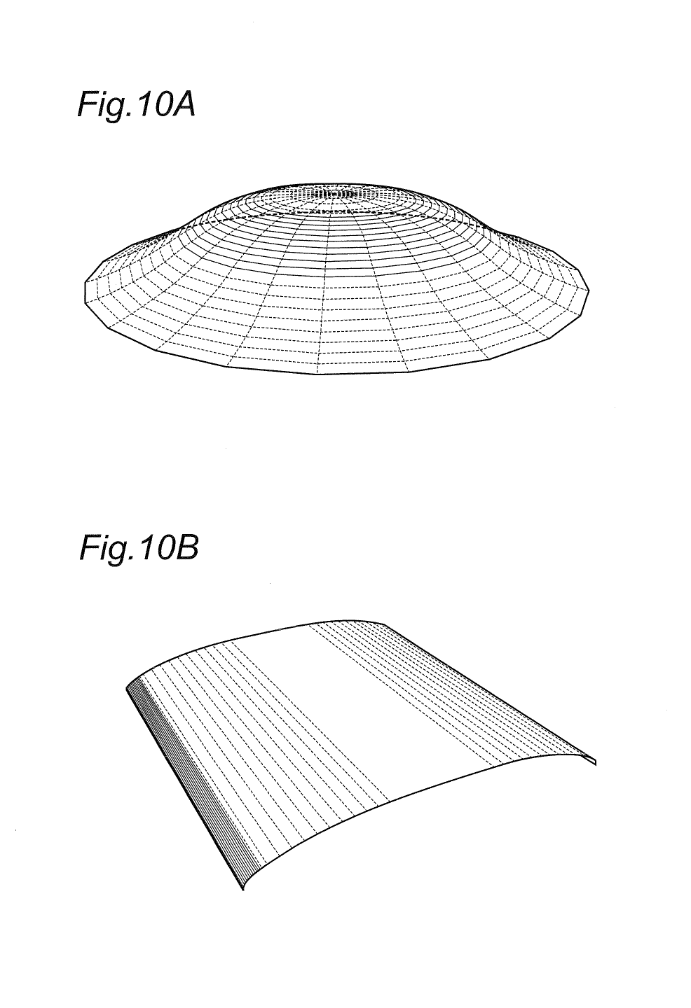

Although the configurations of the above described embodiments have been described by using a case in which the touch panel of the power receiving device used in the power transmission system of the present invention has a planar shape, the touch panel of the present invention is not necessarily specified to be in the planar shape but a touch panel having a curved surface can also be used. FIGS. 10A and 10B are perspective views illustrating two modifications as examples of the shape of the touch panel of the power receiving device used in the power transmission system of the present invention. The touch panel illustrated in FIG. 10A is in a dome shape having a curved surface, and the touch panel illustrated in FIG. 10B is in a shape having a curved surface with a large curvature in both end areas. When the power receiving device with the touch panel having a curved surface as described above is used as the power transmission system, it is preferable to provide the power transmitting device in a shape corresponding to the curved shape of the touch panel so that the power transmitting device and the power receiving device are placed to face each other to be ready for the power transmission. As described above, with the touch panel having a curved shape, the appearance of the power receiving device is allowed to have a dramatically freer design, therefore, can be designed to fulfill the user's demand.

### INDUSTRIAL APPLICABILITY

The present invention is intended to use touch panels used in various electronic appliances such as mobile phone sets, handheld game players, digital cameras, personal data assistants (PDAs), digital audio devices, and digital information devices as the power receiving antenna for the wireless power transmission, and is very versatile and is useful to be used in various portable electronic appliances.

### REFERENCE SIGNS LIST

1, 1A, 1B power receiving device

2, 2A, 2B power transmitting device

3, 3A touch panel

3B, 3C touch panel component

4 hard coat layer

5 movable-side film

6 shrinkable resin layer

7, 7A movable transparent electrode membrane

7B, 7C movable transparent electrode component

8 periphery adhesion layer

9 spacer

10 fixed transparent electrode membrane

10B, 10C fixed transparent electrode component

11 fixed-side support medium

12 display panel

13 deflecting plate

14 color filter substrate

15 TFT substrate

16 deflecting plate

17A power-receiving side active electrode

17B power-transmitting side active electrode

18A power-receiving side passive electrode

18B power-transmitting side passive electrode

19 power transmission circuit

20 control unit

21 switch unit

22 power receiving circuit

23 position detecting circuit

24 power transmitting unit

25 rotating shaft

1. A power receiving device comprising:
a touch panel which is provided on a display panel with a movable transparent electrode membrane and a fixed transparent electrode membrane facing each other and functions as a resistive film type touch sensor;
a position detecting circuit which detects a touched position on the touch panel;
a power receiving circuit which supplies a secondary battery with power received by the movable transparent electrode, the movable transparent electrode serving as an electric field coupling system power receiving antenna; and
a control unit which performs control to selectively switch between the power receiving circuit and the position detecting circuit to drive any one of the circuits.

2. The power receiving device according to claim 1, wherein, when the movable transparent electrode membrane is ready to transmit power, the control unit is configured to perform control to switch from the position detecting circuit to the power receiving circuit so that power is fed to the secondary battery via the movable transparent electrode.

3. The power receiving device according to claim 1, wherein the movable transparent electrode membrane is configured to function as a passive electrode in an electric field coupling system.

4. The power receiving device according to claim 1, wherein the touch panel is split into at least two sections with the movable transparent electrode membrane of the touch panel configured to function as a passive electrode and an active electrode in an electric field coupling system.

5. The power receiving device according to claim 1, wherein the movable transparent electrode membrane functions as a passive electrode in an electric field coupling system, and an active electrode in the electric field coupling system is arranged in parallel with the passive electrode on the same surface.

6. The power receiving device according to claim 1, wherein the movable transparent electrode membrane functions as a passive electrode in an electric field coupling system, and an active electrode in the electric field coupling system is arranged on a surface different from the surface on which the passive electrode is arranged.

7. The power receiving device according to claim 1, wherein the touch panel includes a plurality of touch panel components, and a movable transparent electrode component in at least one touch panel component is configured to function as a passive electrode in an electric field coupling system, and when the movable transparent electrode component is ready to transmit power, the control unit is configured to perform control to switch from the position detecting circuit to the power receiving circuit so that power is fed to the secondary battery via the movable transparent electrode component.

8. The power receiving device according to claim 7, wherein, when the control unit performs control to switch to the power receiving circuit so that power is fed to the secondary battery, at least one of the movable transparent electrode components is configured to function as a touch sensor of the touch panel.

9. A power transmission system comprising:
a power receiving device which includes a secondary battery and has a touch panel, the touch panel being provided on a display panel with a movable transparent electrode membrane and a fixed transparent electrode membrane facing each other and functioning as a resistive film type touch sensor; and
a power transmitting device which includes a power transmission electrode on which the power receiving device is placed, the power transmitting device transmitting power through an electric field coupling system by employing the movable transparent electrode membrane as a power receiving electrode.

10. The power transmission system according to claim 9, wherein the movable transparent electrode membrane of the power receiving device is configured to function as a passive electrode in the electric field coupling system, and when at least a part of the movable transparent electrode membrane faces a passive electrode of the power transmission electrode of the power transmitting device, the power transmission system is configured to perform power transmission.

11. The power transmission system according to claim 9, wherein the touch panel of the power receiving device is split into at least two sections, and the movable transparent electrode membrane of the touch panel is configured to function as a passive electrode and an active electrode in the electric field coupling system, and when at least a part of the movable transparent electrode membrane faces a passive electrode and an active electrode of the power transmission electrode of the power transmitting device, the power transmission system is configured to perform power transmission.

12. The power transmission system according to claim 9, wherein,
in the power receiving device, the movable transparent electrode membrane functions as a passive electrode in the electric field coupling system, and an active electrode and the passive electrode in the electric field coupling system are arranged in parallel on the same surface;
in the power transmitting device, an active electrode and a passive electrode in the electric field coupling system are arranged in parallel on the same surface; and
when power is fed from the power transmitting device to the power receiving device in the electric field coupling system, at least portions of the respective active electrodes and passive electrodes face each other.

13. The power transmission system according to claim 9, wherein,
in the power receiving device, the movable transparent electrode membrane functions as a passive electrode in the electric field coupling system, and an active electrode in the electric field coupling system and the passive electrode are arranged on different surfaces;
in the power transmitting device, an active electrode and a passive electrode in the electric field coupling system are arranged on different surfaces; and
when power is fed from the power transmitting device to the power receiving device in the electric field coupling system, at least portions of the respective active electrodes and passive electrodes face each other.

14. The power transmission system according to claim 9, wherein, in the power receiving device, the touch panel includes a plurality of touch panel components, and the movable transparent electrode component of at least one of the touch panel components functions as a passive electrode in the electric field coupling system; and
in the power transmitting device, a passive electrode is provided as a power transmission electrode which can move to the position facing the passive electrode of the power receiving device.

15. The power transmission system according to claim 14, wherein the power transmitting device is configured to pinch the power receiving device so that the passive electrode of the power transmitting device faces the passive electrode of the power receiving device.

16. The power transmission system according to claim 14, wherein, when power is fed to the power receiving device, at least one of the movable transparent electrode components is configured to function as a touch sensor of the touch panel.
